(19) United States
(12) Patent Application Publication
(10) Pub. No.: US 2008/0236118 A1
(43) Pub. Date: Oct. 2, 2008

(54) Exhaust particulate filter for a machine engine system and assembly method therefor

(76) Inventors: Robert L. Meyer, Metamora, IL (US); Darrel H. Meffert, Sparland, IL (US); Michael J. Pollard, Peoria, IL (US); Herbert F.M. Dacosta, Peoria, IL (US); Ronak Shah, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/728,905

(22) Filed: Mar. 27, 2007

(51) Int. Cl. B01D 50/00; B21D 39/00

(52) U.S. Cl. 55/482; 29/428

(57) ABSTRACT

An exhaust particulate filter for an engine system includes a housing having an inlet, an outlet and a shell shaped to fit the particulate filter within a predefined spatial envelope. Filter elements arranged in a bundle and having a packing arrangement are positioned within the housing. Each of the filter elements includes a perforated tube wrapped with fibrous metallic filter media. The bundle defines a perimetric line at least partially matched to the shape of the shell. An assembly method for a particulate filter includes arranging filter elements in a packing structure within a bundle, the bundle having peripherally located filter elements and internally located filter elements. The filter elements each include a perforated tube wrapped with fibrous metallic filter media. The assembly method further includes positioning the bundle of filter elements within a housing having a shape at least partially matched to a shape of the bundle. A unique method of joining various of the components via swagging is also disclosed. Clamping of the filter media, and joints between filter element and support plates, may be achieved via swagging, for example.

### TECHNICAL FIELD

The present disclosure relates generally to exhaust particulate filters for use in engine systems, and relates more particularly to an exhaust particulate filter and assembly method wherein a bundle of filter elements is positioned within a housing adapted to fit within a predefined spatial envelope.

### BACKGROUND

Operation of internal combustion engines, particularly diesel engines, usually results in the generation of particulate matter (PM) including inorganic species (ash), sulfates, small organic species generally referred to as soluble organic fraction (SOF), and hydrocarbon particulates or “soot.” Various strategies have been used over the years for preventing release of PM into the environment. For some time, on-highway machines have been equipped with exhaust particulate traps as standard equipment. More recently, off-highway machines have been the subject of attention with regard to reducing/controlling PM emissions. While various designs for on-highway exhaust particulate filters have proven to be relatively effective in their intended environment, there are certain shortcomings to the designs if subjected to the demands placed on many off-highway machines.

Conventional exhaust particulate filters used with on-highway machines are available in a wide variety of designs. Commonly, a fibrous material or porous ceramic material is positioned in the path of exhaust exiting an engine, and collects particulates to prevent their escape via the engine exhaust stream. The accumulation of PM within a filter tends to increase the resistance of the filter apparatus to the flow of exhaust gas, necessitating some means of cleaning the filter material, as reduced flow can affect fuel consumption, altitude capability, engine response and exhaust inlet and outlet temperatures. One strategy for removing PM from exhaust filters has been to regenerate the filter via heat or catalysts. In either case, combustion of the accumulated PM is typically induced, and the material is consumed rather than passed out of the machine exhaust system to the environment. As alluded to above, a wide variety of design and operating strategies for exhaust particulate filters have been heretofore proposed. While certain of these designs have worked remarkably well with on-highway machines, in the case of off-highway machines the operating conditions may be such that traditional designs and operating strategies for exhaust particulate filters and regeneration may be less than desirable due to a variety of factors.

For instance, many off-highway machines operate in relatively rugged environments where frequent physical shocks may be experienced. In the case of certain ceramic filters, impact shocks can actually cause the filter material to crack, reducing or entirely compromising the particulate filter's efficacy. While certain recently developed filter materials such as fibers, wools and yarns, both metallic and ceramic, may be less susceptible to impact-induced damage than filters having solid blocks of material, they often suffer from other shortcomings. For example, the wide temperature swings experienced by many exhaust particulate filters, particularly when hot gases or heaters are used to regenerate the filter media, may result not only in physical damage but chemical degradation of the filter material over time. Ceramic filters also tend to conduct heat rather poorly, and therefore can experience temperature “hot spots” where accumulated PM burns off during regeneration.

Another problem presented to engineers attempting to design suitable exhaust particulate filters for off-highway applications relates to the limited amount of space available for mounting filter apparatuses on or in machines. While certain older designs might have had ample space under a machine hood or elsewhere on the machine to mount filtering apparatus, in certain newer designs space may be at more of a premium. It will thus be readily apparent that engineers are faced with a variety of challenges in designing suitable exhaust particulate filters for off-highway applications, namely, fitting an exhaust particulate filter of suitable size, shape, durability and materials within increasingly restricted spatial envelopes.

U.S. Pat. No. 5,293,742 to Gillingham et al. (“Gillingham”) is directed to a trap apparatus having tubular filter elements, for use in particular with diesel engines. In the design set forth in Gillingham, filter tubes surrounded with filter material such as yarn or various foams are used. The filter tubes are positioned within a housing, subdivided into different sectors. During regeneration, parts of the housing can be closed off and the filter tubes therein heated via electric heaters to effect regeneration. While the design of Gillingham may serve its intended purpose, it suffers from a variety of drawbacks. On the one hand, an elaborate system is necessary to direct exhaust gases to only certain parts of the filter apparatus, while restricting flow of exhaust gases to certain parts for regeneration. Restricting flow inherently reduces the efficacy of the filter and possibly the overall exhaust system, as regeneration is often necessary relatively frequently, often numerous times a day depending upon operating conditions. In addition, the Gillingham apparatus may be more vulnerable to damage from rugged off-highway environments due to the techniques used in coupling together its components and may therefore be poorly suited to many such applications.

The present disclosure is direct to one or more of the problems or shortcomings set forth above.

### SUMMARY OF THE DISCLOSURE

In one aspect, the present disclosure provides an exhaust particulate filter for an engine system. The filter includes a housing having an exhaust gas inlet, an exhaust gas outlet and a shell having a shape adapted to fit the particulate filter within a predefined spatial envelope. The filter further includes filter elements having a packing arrangement within the housing. Each of the filter elements includes a perforated tube wrapped with fibrous metallic filter media and configured to filter exhaust gases passing between the inlet and the outlet. The filter elements are arranged in a bundle including peripherally located filter elements and internally located filter elements, the bundle defining a perimetric line which is at least partially matched to the shape of the shell.

In another aspect, the present disclosure provides a machine that includes a housing having a non-cylindrical spatial envelope for an exhaust gas particulate filter. The machine further includes an exhaust gas particulate filter configured to fit within the non-cylindrical spatial envelope, the filter comprising a shell having a shape based at least in part on the non-cylindrical spatial envelope, and filter elements having a packing structure. The filter elements are arranged in a bundle having a shape at least partially matched to the shape of the shell. Each of the filter elements of the bundle includes a perforated tube wrapped with fibrous metallic filter media.

In still another aspect, the present disclosure provides a method of assembling a particulate filter for engine exhaust. The method includes arranging filter elements in a packing structure within a bundle having peripherally located filter elements and internally located filter elements. Each of the filter elements includes a perforated tube wrapped with fibrous metallic filter media. The method further includes positioning the bundle of filter elements within a housing having a shape at least partially matched to a shape of the bundle.

### BRIEF DESCRIPTION OF THE DRAWINGS

FIG. 1 is a perspective view of an off-highway machine, having an exhaust particulate filter, according to one embodiment;

FIG. 2 is a perspective view of a partially disassembled exhaust particulate filter according to one embodiment;

FIG. 3 is a perspective view of a partially disassembled exhaust particulate filter according to another embodiment;

FIG. 4 is a partial exploded view of an exhaust particulate filter similar to that shown in FIG. 3;

FIG. 5 is a sectioned side view of a filter element for an exhaust particulate filter according to one embodiment;

FIG. 6 is an end view of a bundle of filter elements shown supported in an end plate, according to one embodiment;

FIG. 7 is an end view of a bundle of filter elements shown supported in an end plate according to another embodiment; and

FIG. 8 is an end view of a bundle of filter elements shown supported in an end plate according to yet another embodiment.

### DETAILED DESCRIPTION

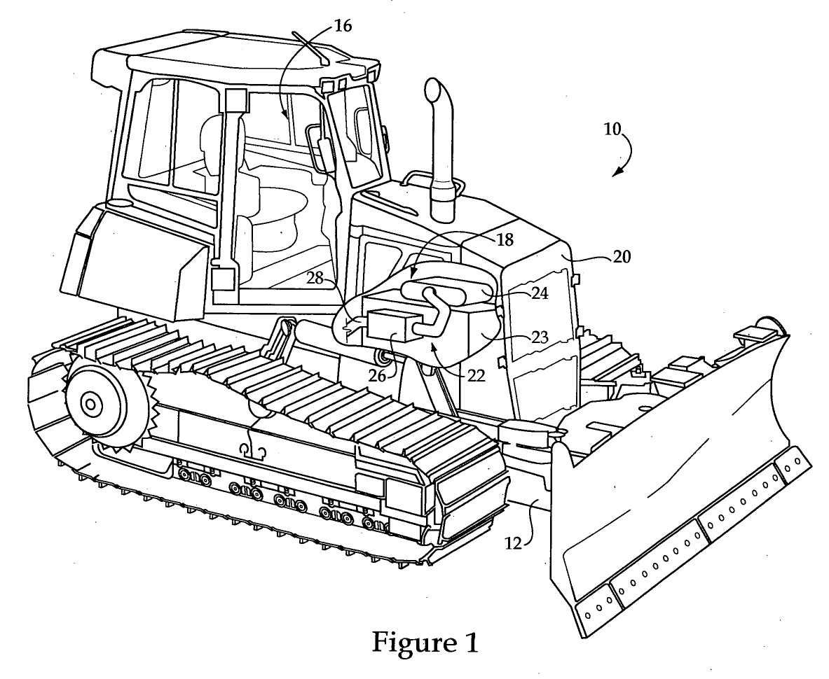

Referring to FIG. 1, there is shown a machine 10 according to one embodiment. Machine 10 is shown in the context of an off-highway track-type tractor having a frame 12, ground engaging tracks 14 mounted to frame 12 and an operator cab 16 also mounted to frame 12. Machine 10 may further include an engine system 22 having an engine 23 such as a compression ignition diesel engine, and an exhaust particulate filter 24 having a design and configuration adapted to fit filter 24 within a predefined spatial envelope. The predefined spatial envelope may be within an engine compartment 18. This space available for mounting filter 24 may be dictated by a variety of factors, including size and shape of various components of engine system 22 such as a turbocharger 26 coupled with an exhaust pipe 28, a hood 20, frame 12 and various other parts of machine 10 depending upon its particular design. Other concerns may also dictate the location, size and shape of the predefined spatial envelope for filter 24. For example, it may be desirable in some instances to locate filter 24 outside of engine compartment 18 for purposes such as thermal management of engine 23, or simply for matters of convenience.

In any event, it should be appreciated that the present disclosure is not limited to any particular location or configuration of the spatial envelope within which filter 24 will be used. For reasons which will be apparent from the following description, flexibility in design and configuration of filter 24 is contemplated to enable its use despite a broad spectrum of spatial and shape constraints. While off-highway machines such as trucks, tractors, loaders, graders, scrapers, etc. may especially benefit from the use of shape flexible exhaust particulate filters as described herein, the present disclosure is not thereby limited. Machine 10 might be an on-highway machine, or even a stationary machine. Further still, while machines having spatial constraints for filter mounting are mentioned herein, the present disclosure is also not limited in this regard. Filter 24 and its attendant design, materials and configuration may provide advantages even where fitting of a filter within a restricted space is not of primary concern. These and other advantages are further described herein by way of illustrative embodiments.

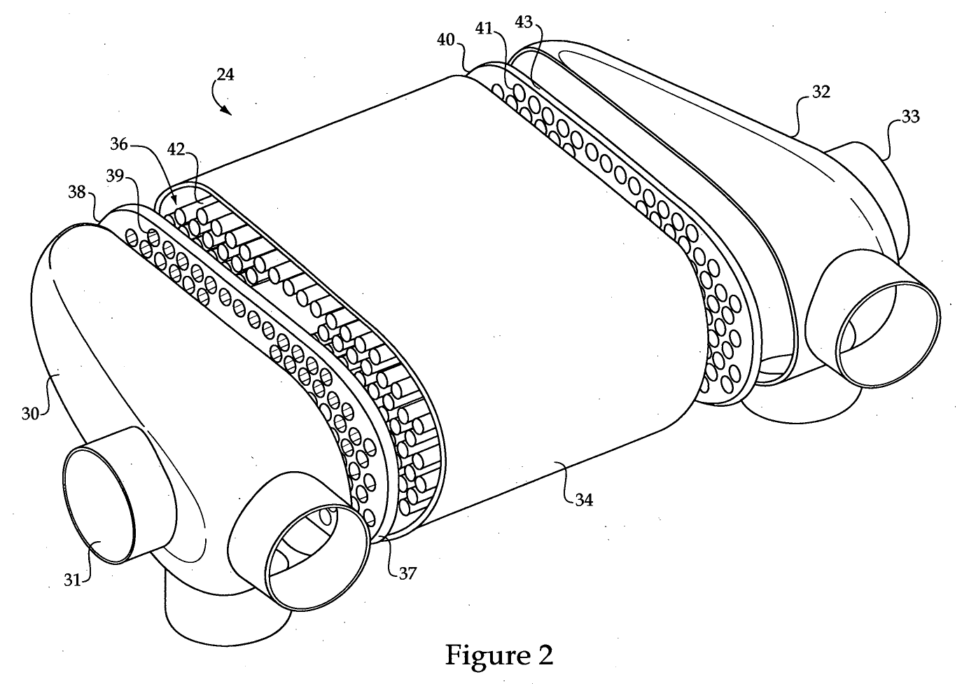

Referring also to FIG. 2, there is shown a partially disassembled exhaust particulate filter 24, similar to filter 24 shown in FIG. 1. Filter 24 may include an inlet portion 30 having an exhaust gas inlet 31, an outlet portion 32 having an exhaust gas outlet 33 and a shell 34. Other fluid connections to filter 24 may exist for various purposes, such as exhaust gas recirculation, exhaust gas cooling and connecting with one or more turbochargers. Inlet portion 30, outlet portion 32 and shell 34 may together comprise a filter housing having a shape. In certain embodiments, the shapes of one or more of the respective housing components 30, 32 and 34 may be adapted to fit filter 24 within the aforementioned predefined spatial envelope. For example, filter 24 may have a non-circular cross-section such as a generally oblong cross-section in the FIG. 2 embodiment. The cross-sectional shape of filter 24 may be tailored such that it may fit within the spatial envelope of engine compartment 18 between engine 23 and hood 20 in machine 10. In other embodiments, different shapes corresponding to different predefined spatial envelopes may be appropriate.

Shape flexibility of filter 24, as well as other advantages, arise in part from the manner in which filter 24 is designed. Filter 24 may include a plurality of identical filter elements 42, for example twenty or more individual filter elements arranged in a bundle 36. The use of numerous identical filter elements allows the general shape of filter 24 to be quite flexible as compared to many earlier filter designs, without sacrificing efficacy. Each of filter elements 42 in bundle 36 may filter exhaust gases passing from exhaust gas inlet 31 to exhaust gas outlet 33 and may further be supported via a first support plate 38 and a second support plate 40, each having a plurality of holes 39 and 41, respectively, configured to support filter elements 42. Holes 39 and 41 may be arranged in a pattern corresponding to an arrangement and distribution of filter elements 42 in bundle 36. Each of support plates 38 and 40 may include an outer perimeter or edge 37 and 43, respectively, which is matched to a shape of shell 34 and may also be matched to shapes of inlet portion 30 and outlet portion 32. Support plates 38 and 40 may have oblong shapes similar to that shown in FIG. 2, or they might have a wide variety of other shapes such as triangular, circular, square, trapezoidal or even irregular and non-polygonal shapes. Bundle 36 may have an essentially limitless variety of configurations, imparting shape flexibility to filter 24 limited generally only to manufacturing capabilities and/or practicalities for the various components.

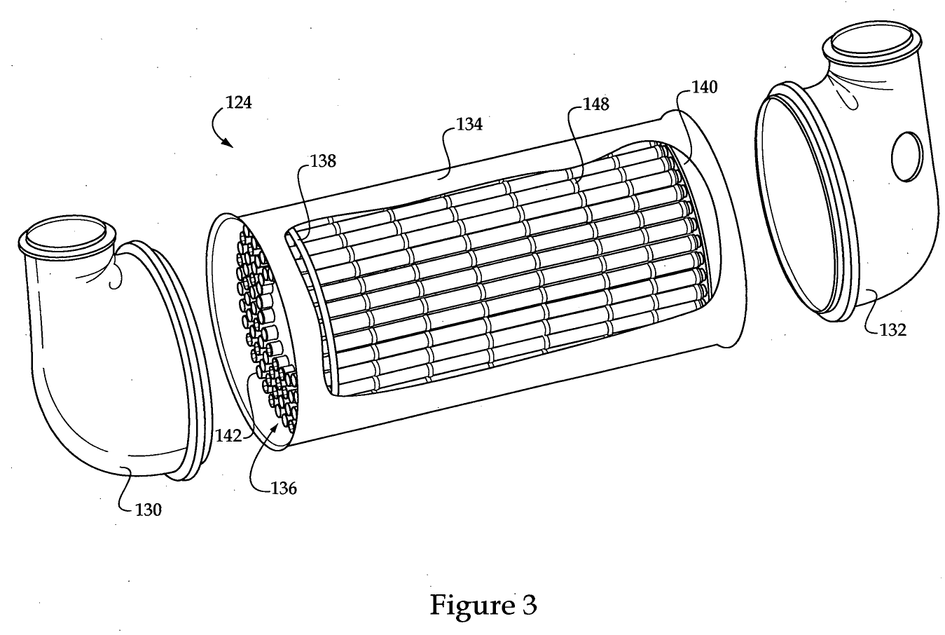

Turning now to FIG. 3, there is shown another filter 124 similar in design to filter 24 described above, shown in partial cut-away, but having a generally cylindrical shape. Filter 124 may be used where a matching cylindrical spatial envelope exists, or where space and shape restrictions are relatively minimal and filter 124 is made cylindrical for manufacturing or handling convenience, etc. Filter 124 may include a bundle of filter elements 136, an inlet portion 130, a shell 134, an outlet portion 132 and first and second support plates 138 and 140 for bundle 136. Each of filter elements 142 may include a plurality of clamps 148, further described herein.

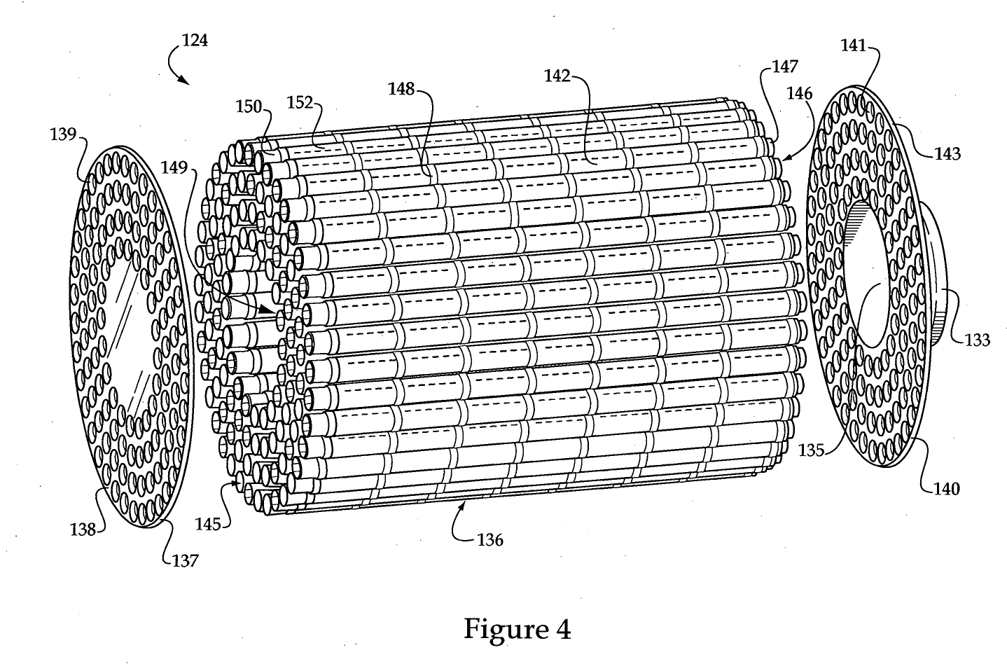

Turning now to FIG. 4, there is shown a partial exploded view of filter 124 wherein support plates 138 and 140 have been removed from engagement of holes 139 and 141 with filter elements 142. It should be appreciated that the following description of filter 124 is applicable to other filters and related systems of the present disclosure, including filter 24 described above, except where stated otherwise. In the FIG. 4 version, filter elements 142 of bundle 136 are arranged in a band about a center passage 149. Center passage 149 may be provided to enable fluid flow through filter 124 without resulting in excessive back pressure during engine system operation. In other words, since filter elements 142 act as a flow restriction to engine exhaust, passage 149 can provide a relatively unrestricted outlet for exhaust gases to avoid overly inhibiting exhaust gas flow through filter 124. Passage 149 may be fluidly connected with one of inlet portion 130 and outlet portion 132 and fluidly blocked from the other of inlet portion 130 and outlet portion 132, except by way of fluid connections through filter elements 142. Support plate 138 may be blocked in a region(s) corresponding to passage 149 to prevent raw exhaust gas flowing into the same in one embodiment. Support plate 140 may further include a flange 133 defining an outlet passage 135 connecting with passage 149 for passing filtered exhaust gases to a tailpipe, exhaust stack, turbocharger, recirculation loop, etc.

Each of filter elements 142 may include a first, open end 145 and a second, closed end 146. In one embodiment, filter elements 142 are arranged such that their first, open ends 145 are supported in support plate 138 and fluidly connected with an interior of inlet portion 130 for receiving raw exhaust gases, and their second ends 146 supported in support plate 140. Thus, all of filter elements 142 may be oriented identically. Other embodiments are contemplated, however, wherein bundle 136 consists of filter elements in both orientations such that exhaust gas passes into open ends of only a portion of filter elements 142, then into counter-oriented filter elements, and finally passes out to outlet portion 132 via filter elements having their open ends 145 fluidly connected therewith.

Each of the respective filter elements may include a tube 150 wrapped with fibrous filter media 152 such as a mat of sintered metal fibers, or other media. A plurality of layers of one or more mats of sintered metal fibers may be wrapped about each of tubes 150 in one embodiment. While uniformly porous media 152 may be used, in other embodiments the media porosity may change with each successive wrapped layer.

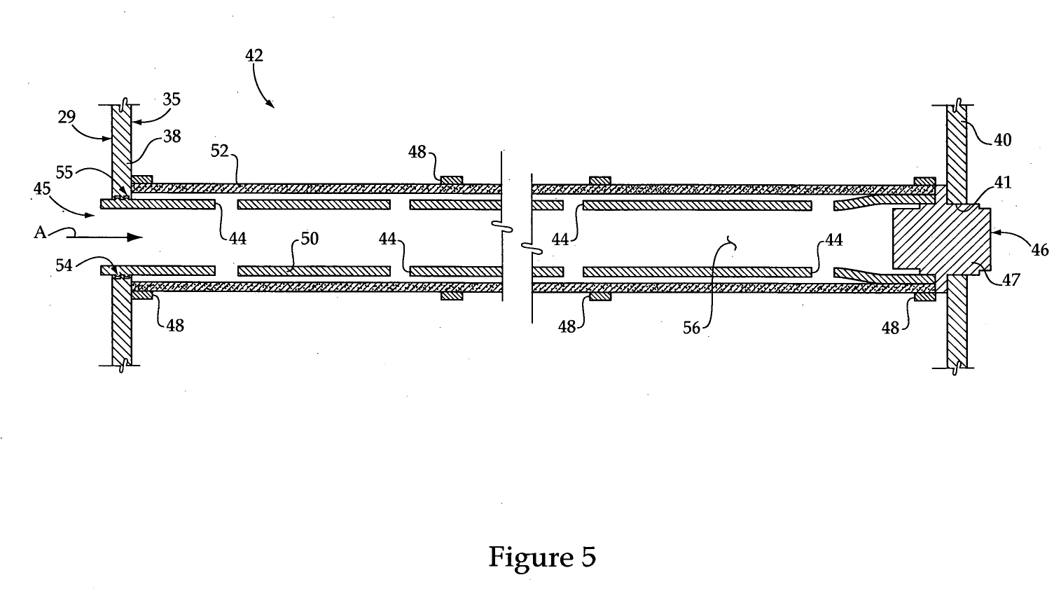

Turning now to FIG. 5, there is shown a lengthwise cross-section through a filter element 42. The illustration and accompanying description of filter element 42 in FIG. 5 should be understood to be similarly applicable to filter elements of the other embodiments contemplated herein. Filter element 42 is shown having its first end 45 supported in a hole 39 of support plate 38. The second end 46 of filter element 42 is shown supported in a hole 42 in support plate 40. Further illustrated are a plurality of perforations or apertures 44 in tube 50 to enable exhaust gases passing in through open end 45, shown via arrow A, to pass from an interior 56 of tube 50 out through walls of tube 50, and thenceforth through filter media 52.

Filter element 42 may further include a plug, for example a stepped or tapered plug 47 configured to fluidly seal second end 46. In one embodiment, plug 47 will have an outer diameter sufficiently less than an inner diameter of the corresponding hole 41 such that relative motion between filter element 42 and support plate 40 is possible. By loose-fitting plug 47 in support plate 40, a feature which may be common to all of the filter elements and filter designs described herein, filter element 42 may move relative to support plate 40 due to expansion and contraction resulting from thermal cycling. Differing rates of thermal expansion among filter elements within a particular filter, as well as differing thermal expansion rates between the filter elements and the housing, etc. can be accommodated by the loose-fit plugs, permitting their associated filter elements to remain supported. In certain embodiments, filter elements relatively closer to a center of a bundle of which they are a part may increase in temperature, and thus expand, relatively more rapidly than filter elements positioned relatively closer to the outside of a bundle. Relatively wide temperature swings may occur during ordinary operation as well as during filter regeneration and, hence, this feature can reduce or eliminate the risk of component failure due to temperature changes or differences among components.

Filter regeneration in certain embodiments will typically take place with a heating device configured to heat filter elements 42, and in particular filter media 52, to a temperature sufficient to initiate and maintain combustion of accumulated soot. In one contemplated embodiment, an auxiliary regeneration device will be positioned upstream of filter 24 to inject and ignite fuel in the engine exhaust stream which is burned to increase the temperature of gases passing through filter 24. Other means such as electric heaters might also be used.

In addition to the described loose-fit of plug 47, certain other features of filters described herein may be adapted to the relatively wide temperature swings and extreme temperatures typically encountered during service. With continued reference to FIG. 5, filter element 42 may be coupled with support plate 38 in a manner unique among exhaust particulate filters. In particular, tube 50 may include a radially expanded portion 54 received in one or more grooves 55 located in support plate 38 between its front and back faces 29 and 35, respectively, and coaxial with hole 39. Radially expanding tube 50 into grooves 55 may be achieved via a process known in the art as swagging. In a typical swagging operation, a rotary tool such as a mandrel (not shown) may be positioned within first end 45 of tube 50 and used to expand tube 50 into grooves 55. The resultant joint will provide a fluid seal to inhibit exhaust gases leaking past the interface of tube 50 and support plate 38 rather than into tube 50, and will also provide a relatively strong, purely mechanical joint resistant to deformation and damage due to temperature changes and temperature extremes while in service. A relatively greater number of grooves may increase strength of the joint in many instances. While swagging may provide one practical implementation strategy, other means such as adhesives, welding, or bolted seals might also be used without departing from the scope of the present disclosure.

Clamps 48 may also be used to clamp filter media 52 about tube 50 to join together the components without the need for welding, adhesives, etc. In one embodiment clamps 48 may be compressed, also via a swagging technique, wherein annular clamp elements are positioned about filter media 52 on each of tubes 50, then reduced in diameter to effect a relatively tight clamping force on media 52. Similar to formation of the joint via expanded portion 54 and groove 55, other techniques might be used for securing filter media 52 in place about tube 50. An advantage attendant to the use of swagging and similar techniques to form connections and secure materials of filters described herein is the lack of significant heating of the respective materials. In other words, because swagging is essentially a cold forming technique known or desirable properties of tube 50, support plate 38, clamps 48 and other components are not compromised by the joining techniques used. Another advantageous feature of the present disclosure is that filter element 42 may be formed from materials having identical coefficients of thermal expansion. Accordingly, during thermal cycling the relative expansion and contraction of the various components, including tube 50, filter media 52, clamps 48, etc. may be approximately the same. This feature of certain filter embodiments according to the present disclosure provides a reduced risk of component cracking, seal failure and other problems while in service. In one embodiment, tube 50 and possibly support plates 38 and 40 may be formed from 439 stainless steel, whereas filter media 52 may include an iron, chromium and aluminum alloy. All or substantially all of the components of filters according to the present disclosure may consist of one form or another of ferritic stainless steel.

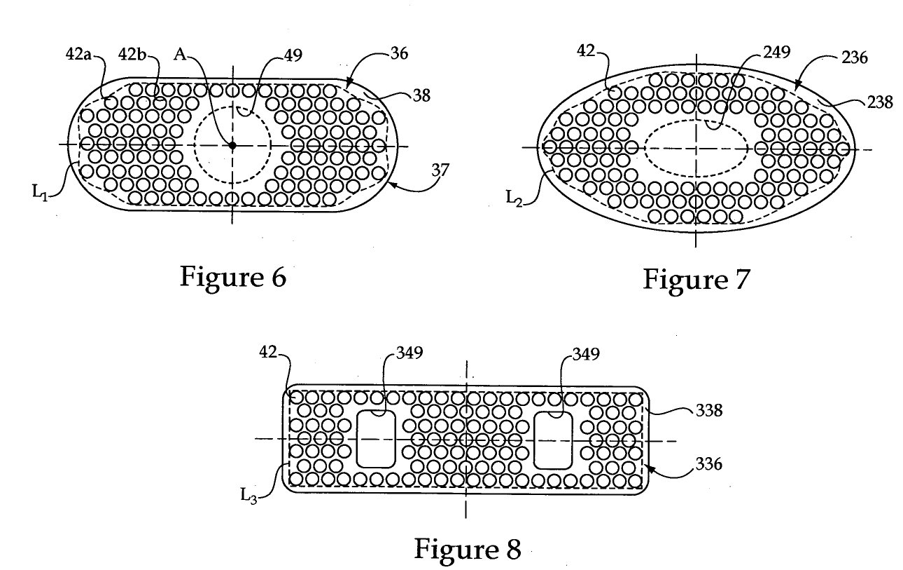

Turning now to FIG. 6, there is shown an end view of bundle 36 supported in support plate 38. A passage 49 for reducing back pressure is shown in phantom, and a longitudinal axis A of filter 24 is also shown. While passages such as passage 49 may be used in many embodiments, in others no passage may exist, or numerous “passages” or other voids among filter elements 42. Bundle 36 may include peripherally located filter elements 42a and internally located filter elements 42b, having a packing arrangement. In one embodiment, the respective filter elements 42a and 42b may have a hexagonal packing arrangement, generally permitting a maximum number of filter elements to be located within a given volume, based on the available spatial envelope of machine 10, for example. Where a hexagonal packing arrangement is used, a majority of the internally located filter elements 42b will typically be surrounded by at least five other filter elements, whereas a majority of peripherally located filter element 42a will typically be surrounded by fewer than five other filter elements. Internally located filter elements 42b will generally be greater in number than peripherally located filter elements 42a. In accordance with the packing arrangement, the filter elements of bundle 36 may be positioned at an average distance from one another that is less than an average diameter of the filter elements comprising bundle 36. This average distance may also be an equal distance between all of the respective filter elements, in accordance with the packing arrangement. In certain embodiments, the filter elements of bundle 36 may be positioned at an average distance from one another that is less than one half an average diameter of the filter elements comprising bundle 36. It may be desirable to pack the respective filter elements in bundle 36 as tightly as practicable to maximize the amount of surface area available for filtering exhaust gases. In one embodiment, the filter elements may be packed such that their respective clamps 48 are located at similar positions relative to the lengths of the filter elements, clamps 48 being spaced from one another by about 1.5 millimeters. It should be appreciated that the number of filter elements surrounding any one filter element, the proportion of internally located filter elements relative to peripherally located filter elements, and other factors, may vary based on the specific filter shape, filter size, filter element diameter, etc.

The peripherally located filter elements 42a may define a perimetric line which is at least partially matched to a shape of support plate 38. It will be recalled that support plate 38 may have a peripheral edge 37 at least partially matched to a shape of shell 34; hence, the perimetric line defined by peripherally located filter elements 42, denoted L₁ in FIG. 6, will typically be at least partially matched to a shape of shell 34. In one embodiment, perimetric line L₁ may consist of a line tangent to peripherally located filter elements 42a.

Turning to FIG. 7, there is shown another embodiment having a support plate 238 supporting a plurality of filter elements 242 arranged in a bundle 236. Bundle 236 may consist of peripherally located filter elements and internally located filter elements, also having a packing arrangement and positioned in a band about a fluid passage 249. A perimetric line L₂ is defined by the peripherally located filter elements and is at least partially matched to a shape of support plate 238, similar to the FIG. 6 embodiment but having an oval rather than an oblong shape. FIG. 8 illustrates yet another bundle 336 of filter elements 42 having a packing arrangement and supported via a support plate 338. Peripherally located filter elements define another perimetric line L₃ which is at least partially matched to a shape of support plate 338. In the FIG. 8 embodiment, two separate fluid passages 349 are shown in phantom, and support plate 338 has an approximately rectangular shape.

### INDUSTRIAL APPLICABILITY

Referring to the drawings generally, the present disclosure provides substantially improved means for fitting exhaust particulate filters within restrictive spaces, but also provides advantages with regard to manufacturing and assembly. Filter elements 42, 142 may be manufactured in large numbers with relative ease. Rather than tailoring a particular filter element around an overall exhaust particulate filter design, the present disclosure enables many identical filter elements to be used in assembling filters having a wide variety of sizes and shapes.

During a typical manufacturing/assembly process, tubes 50, 150 will initially be wrapped with filter media 52, 152. As mentioned above one layer or a plurality of layers of filter media 52, 152 may be wrapped about each tube. Clamps 48, 148 may then be positioned at a plurality of spaced apart locations along each tube 50, 150 and clamped in place by reducing their diameters to secure filter media 52, 152. Prior to or following clamping of clamps 48, 148, plugs 47, 147 may be inserted into ends of each tube 50.

When an appropriate number of individual filter elements 42, 142 has been obtained, filter elements 42, 142 may be joined with support plate 38, 138, for example via the swagging technique described herein to simultaneously form a fluid seal and mechanical joint for supporting the respective filter elements 42, 142. The plugged ends of each filter element 42, 142 may then be positioned in appropriate holes 41, 141 in support plate 40. The partially assembled filter may then be positioned within a shell 34, 134 having a shape based at least in part on an available spatial envelope in or on a machine, and inlet and outlet portions 30, 130 and 32, 132, respectively, coupled therewith to complete assembly.

All of the filter embodiments described herein, and in particular as illustrated in FIGS. 6-8, include bundles of filter elements 36, 236 and 336 which can be at least partially matched to a shape of parts of a filter/filter housing wherein the respective bundles are disposed. Rather than being restricted solely to cylindrical shapes as in many earlier filter design strategies, the present disclosure provides for vastly greater flexibility in filter shape design. This aspect is considered to greatly improve the ease with which exhaust particulate filters may be fitted within spatially restrictive or spatially complex spaces within or on machines. Further, the use of robust materials having similar or identical coefficients of thermal expansion and the use of the described joining techniques will result in a filter capable of withstanding shocks and vibrations associated with rugged off-highway environments, as well as thermal cycling and relatively extreme temperatures.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For example, while filter elements 42, 142 may be used with sintered metal fibrous materials as filter media 52, 152, the present disclosure is not thereby limited. Foams and various other materials, located inside or outside of tubes 50, 150 might instead be used, depending upon the application. In still other embodiments, multiple tubes might be used with each filter element, to provide for additional mechanical integrity. An inner perforated tube and an outer perforated tube, with filter media between the respective tubes, is contemplated. Further, while tubes 50, 150 will typically be cylindrical, other shapes might be used where appropriate without departing from the intended spirit and scope of the present disclosure. Further still, while much of the foregoing description focuses on off-highway applications, it is emphasized that many on-highway applications are contemplated, for instance the use of the filters described herein in an over-the-road hauling truck, etc. Finally, while use as an exhaust particulate filter represents a primary application, the present disclosure may be expanded upon in the exhaust aftertreatment context. Rather than only filtering particulates, the filters constructed and designed as described herein might also incorporate catalysts for NOₓ reduction, CO reduction, or some other form of exhaust aftertreatment. Such catalysts could be integrated with the filter media, or disposed elsewhere in the system. Other aspects, features and advantages will be apparent upon an examination of the attached drawings and appended claims.

What is claimed is:

1. An exhaust particulate filter for an engine system comprising:
a housing having an exhaust gas inlet, an exhaust gas outlet and a shell having a shape adapted to fit said particulate filter within a predefined spatial envelope; and
filter elements having a packing arrangement within said housing, each of said filter elements including a perforated tube wrapped with fibrous metallic filter media and configured to filter exhaust gases passing between said inlet and said outlet;
said filter elements being arranged in a bundle comprising peripherally located filter elements and internally located filter elements, said bundle defining a perimetric line which is at least partially matched to the shape of said shell.

2. The exhaust particulate filter of claim 1 wherein at least a portion of said internally located filter elements are each surrounded by adjacent filter elements according to the packing arrangement.

3. The exhaust particulate filter of claim 2 wherein said filter elements have a hexagonal packing arrangement and are equally spaced from one another within said bundle.

4. The exhaust particulate filter of claim 2 wherein said perimetric line is tangent to said peripherally located filter elements.

5. The exhaust particulate filter of claim 4 comprising at least twenty identical filter elements arranged in said bundle, wherein each of said filter elements arranged in said bundle includes a diameter and is spaced from adjacent filter elements an average distance which is less than said diameter.

6. The exhaust particulate filter of claim 5 wherein said fibrous metallic filter media comprises at least one sintered mat of metal fibers.

7. The exhaust particulate filter of claim 6 wherein each of said filter elements further comprises a plurality of clamps configured to clamp the filter media about the corresponding tube.

8. The exhaust particulate filter of claim 7 wherein each of said filter elements includes a first, open end and a second, closed end, said housing further comprising a first support plate having holes therein configured to support one of the first and second ends of each of said filter elements and a second support plate also having holes therein configured to support one of the first and second ends of each of said filter elements, said first and second support plates each having a perimeter matched to the shape of said shell.

9. The exhaust particulate filter of claim 8 wherein said shell comprises a longitudinal axis and includes a non-circular cross section perpendicular to said axis.

10. The exhaust particulate filter of claim 8 wherein said bundle of filter elements is arranged in at least one band extending about a passage opening to one of said exhaust gas inlet and said exhaust gas outlet but blocked from the other of said exhaust gas inlet and said exhaust gas outlet.

11. The exhaust particulate filter of claim 8 wherein said first support plate includes a front face and a back face, said holes extending between said front and back faces, and a plurality of grooves each coaxial with one of said holes and disposed between said front and back faces, wherein each of said filter elements has its first end positioned in one of said holes and includes a radially expanded portion extending into the corresponding groove.

12. The exhaust particulate filter of claim 8 wherein said tubes, said fibrous filter media and said first and second support plates have identical coefficients of thermal expansion.

13. A machine comprising:
a housing having a non-cylindrical spatial envelope for an engine exhaust gas particulate filter; and
an exhaust gas particulate filter configured to fit within said non-cylindrical spatial envelope, said filter comprising a shell having a shape based at least in part on said non-cylindrical spatial envelope and filter elements having a packing structure and arranged in a bundle having a shape at least partially matched to the shape of said shell, each of the filter elements of said bundle comprising a perforated tube wrapped with fibrous metallic filter media.

14. The machine of claim 13 wherein said bundle includes peripherally located filter elements and internally located filter elements, said bundle defining a perimetric line tangent to said peripherally located filter elements which is at least partially matched to the shape of said shell.

15. The machine of claim 14 wherein said exhaust gas particulate filter further includes a first support plate having a plurality of holes therein and a second support plate also having a plurality of holes therein, said support plates being configured to support ends of said filter elements within said holes.

16. The machine of claim 15 wherein said shell has a longitudinal axis and comprises an oblong cross section perpendicular to said longitudinal axis.

17. The machine of claim 15 wherein said shell has a longitudinal axis and comprises a rectangular cross section perpendicular to said longitudinal axis.

18. A method of assembling a particulate filter for engine exhaust comprising the steps of:
arranging filter elements in a packing structure within a bundle, the bundle having peripherally located filter elements and internally located filter elements, each of the filter elements including a perforated tube wrapped with fibrous metallic filter media; and
positioning the bundle of filter elements within a housing having a shape at least partially matched to a shape of the bundle.

19. The method of claim 18 further comprising a step of securing the fibrous metallic filter media about the tubes at least in part by reducing a diameter of a plurality of annular clamps positioned about the fibrous metallic filter media of each of the filter elements, prior to the arranging step.

20. The method of claim 19 further comprising a step of coupling ends of the filter elements with a support plate configured to support the bundle within the housing, including a step of expanding the tubes of each of the filter elements into grooves located in the support plate.
